(19) United States
(12) Patent Application Publication
(10) Pub. No.: US 2008/0078493 A1
(43) Pub. Date: Apr. 3, 2008

(54) Fabricating method of ceramic thin plate

(75) Inventors: Chih-Hung Wei, Taoyuan Hsien (TW); Yu-Ping Hsieh, Taoyuan Hsieh (TW)

Correspondence Address: BIRCH STEWART KOLASCH & BIRCH, PO BOX 747, FALLS CHURCH, VA, 22040-0747, US

(73) Assignee: DELTA ELECTRONICS, INC.

(21) Appl. No.: 11/889,141

(22) Filed: Aug. 9, 2007

(30) Foreign Application Priority Data
Sep. 29, 2006 (TW) 095136192

(51) Int. Cl. B29C 65/02

(52) U.S. Cl. 156/64; 156/89.11

(57) ABSTRACT

A fabricating method of a ceramic thin plate includes the steps of providing at least one first pre-mold plate and at least two second pre-mold plates; stacking up the first pre-mold plate and the second pre-mold plates so that the first pre-mold plate is disposed and sandwiched between the two second pre-mold plates; and sintering the first pre-mold plate and the second pre-mold plates at the sintering temperature of the first pre-mold plate so as to make the first pre-mold plate to form the ceramic thin plate. The sintering temperature of the second pre-mold plate is higher than that of the first pre-mold plate.

### CROSS REFERENCE TO RELATED APPLICATIONS

This Non-provisional application claims priority under 35 U.S.C. §119(a) on Patent Application No(s). 095136192, filed in Taiwan, Republic of China on Sep. 29, 2006, the entire contents of which are hereby incorporated by reference.

### BACKGROUND OF THE INVENTION

1. Field of Invention

The present invention relates to a fabricating method of a ceramic thin plate and, in particular to a fabricating method of a ceramic thin plate, which is planar without a warp.

2. Related Art

Recently, the high element density has become a trend of developing electronic products while portable information electronic products and mobile communication products are developed toward the trends of miniaturization, multi-function, high reliability and low price. Thus, active devices and passive devices used in a circuit have been developed toward the trends of integration, system-on-chip and modularization so that the size of the circuit can be effectively reduced, the cost can be reduced, and the competition ability of the product can be enhanced.

The development of the low temperature co-fired ceramics (LTCC) technology increases the volume availability of the electronic product by integrating the circuits of the electronic elements, including the passive devices and the active devices, in a multi-layer structure. As shown in FIG. 1, a conventional LTCC substrate 1 applied to the high-frequency wireless communication element has a multi-layer structure formed by stacking up a plurality of ceramic thin plates 11. A conductive layer 111 and an electrical element 112, such as a resistor, a capacitor or an inductor, are disposed on each layer or between two adjacent layers. The conductive layer 111 may be connected to another conductive layer 111 and another electrical element 112 via the through hole(s) 113. The conductive layer 111 or the electrical element 112 is formed on a surface of the ceramic thin plate 11 by the thick-film printing technology followed by the multi-layer press-forming and the process of sintering at a temperature lower than 1000° C.

However, the ceramic thin plate 11 may have the problem of deformation, such as contraction, distortion, and curved condition because the contraction amounts between the ceramic thin plates 11 in different layers may be different from each other or one another, or voids are generated due to the volatilized solvent or adhesive during the sintering process. This phenomenon becomes obvious when a thinner ceramic thin plate is being manufactured. That is, the yield and the reliability of the LTCC substrate 1 will be affected. To achieve this problem, the prior art utilizes the mechanical force to restrict the directions of the deformation so as to prevent the warp. However, this method can only applied to the batch manufacturing instead of the mass production in a tunnel kiln.

### SUMMARY OF THE INVENTION

In view of the foregoing, the present invention is to provide a fabricating method for a ceramic thin plate, which is planar without a warp and has good properties such as high density, dielectric and quality.

In view of the foregoing, the present invention discloses a fabricating method of a ceramic thin plate including the following steps. Firstly, at least one first pre-mold plate and at least two second pre-mold plates are provided. A sintering temperature of the second pre-mold plates is higher than that of the first pre-mold plate. Then, the first pre-mold plate and the second pre-mold plates are stacked up, while the first pre-mold plate is disposed and sandwiched between the two second pre-mold plates. Finally, the first pre-mold, plate and the second pre-mold plates are sintered at the sintering temperature of the first pre-mold plate. The first pre-mold plate is sintered to form the ceramic thin plate.

In addition, the present invention also discloses another fabricating method of a ceramic thin plate including the following steps. Firstly, a first pre-mold plate, a second pre-mold plate and a third pre-mold plate are provided. A sintering temperature of each of the second pre-mold plate and the third pre-mold plate is higher than that of the first pre-mold plate. Then, the first pre-mold plate, the second pre-mold plate and the third pre-mold plate are stacked up. The first pre-mold plate is disposed and sandwiched between the second pre-mold plate and the third pre-mold plate. Finally, the first pre-mold plate, the second pre-mold plate and the third pre-mold plate are sintered at the sintering temperature of the first pre-mold plate. The first pre-mold plate is sintered to form the ceramic thin plate.

As mentioned above, the fabricating method of a ceramic thin plate according to the present invention is to dispose a pre-mold plate with a lower sintering temperature, i.e. the first pre-mold plate, between two pre-mold plates with a higher sintering temperature, i.e. the second and third pre-mold plates. Then, the stacked pre-mold plates are sintered at the lower sintering temperature so as to make the first pre-mold plate to form a ceramic thin plate, while the second and third pre-mold plates are not sintered yet. In the present invention, the second and third pre-mold plates are used to apply stress on both opposite surfaces of the first pre-mold plate during a sintering process. Accordingly, the fabricated ceramic thin plate can be planar and without a warp and have good properties such as the high density, dielectric and quality.

### BRIEF DESCRIPTION OF THE DRAWINGS

The present invention will become more fully understood from the detailed description given herein below illustration only, and thus is not limitative of the present invention, and wherein:

FIG. 1 is a schematic illustration showing a conventional LTCC substrate;

FIG. 2 is a flow chart showing a fabricating method of a ceramic thin plate according to a first embodiment of the present invention;

FIGS. 3 to 4 are schematic illustrations showing the configuration of the first pre-mold plate and the second pre-mold plates according to the fabricating method of FIG. 2; and

FIG. 5 is a flow chart showing a fabricating method of a ceramic thin plate according to a second embodiment of the present invention.

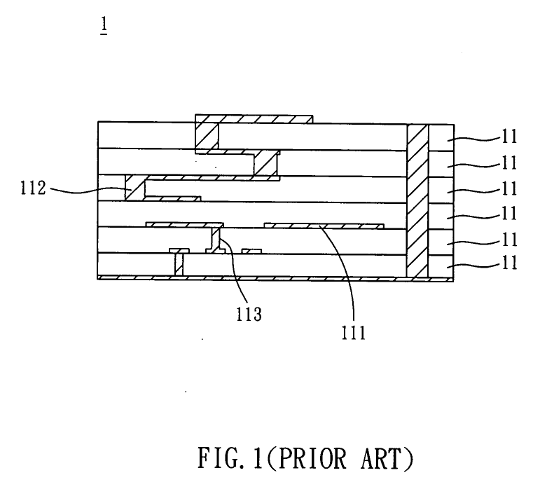

### DETAILED DESCRIPTION OF THE INVENTION

The present invention will be apparent from the following detailed description, which proceeds with reference to the accompanying drawings, wherein the same references relate to the same elements.

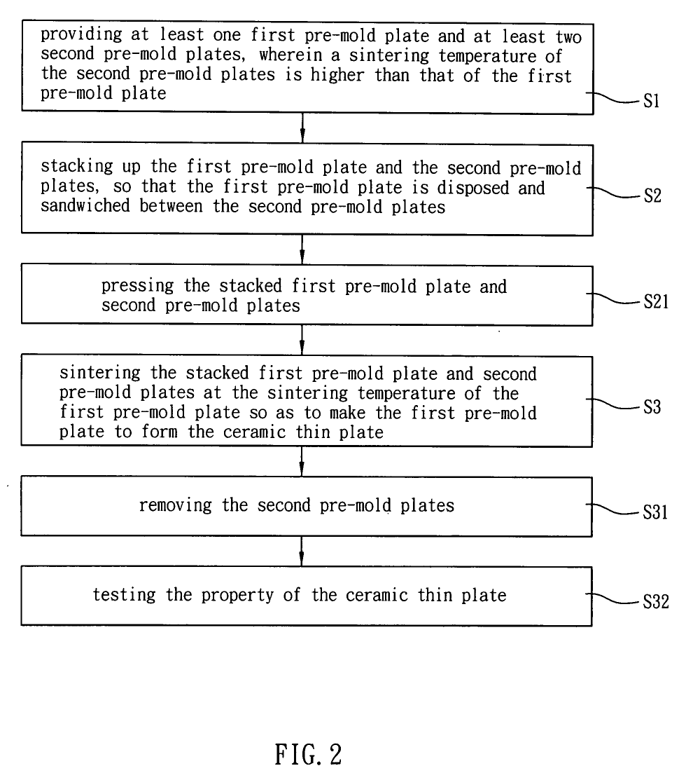

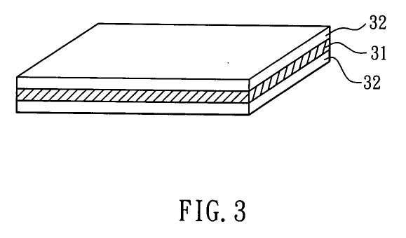

Referring to FIGS. 2 and 3, the fabricating method of the ceramic thin plate according to a first embodiment of the present invention includes steps S1 to S3. In step S1, at least one first pre-mold plate 31 and at least two second pre-mold plates 32 are provided. In the embodiment, the sintering temperature of the second pre-mold plates 32 is higher than the sintering temperature of the first pre-mold plate 31. Next, in step S2, the first pre-mold plate 31 and the second pre-mold plates 32 are stacked up, while the first pre-mold plate 31 is disposed and sandwiched between the two second pre-mold plates 32. In step S3, the stacked first pre-mold plate 31 and second pre-mold plates 32 are sintered at the sintering temperature of the first pre-mold plate 31 during a sintering process. Since the sintering temperature of the first pre-mold plate 31 is lower than the sintering temperature of the second pre-mold plate 32, only the first pre-mold plate 31 will be sintered and then forms the ceramic thin plate, and the two second pre-mold plates 32 are not sintered. During the sintering process, the two second pre-mold plates 32 provide the pressure on both opposite surfaces of the first pre-mold plates 31 so as to prevent the first pre-mold plate 31 from generating a warp.

In step S1, at least one first pre-mold plate 31 with lower sintering temperature and at least two second pre-mold plates 32 with higher sintering temperature are provided. The first pre-mold plate 31 and second pre-mold plates 32 are fabricated by mixing at least one ceramic material with an inorganic adhesive. The ceramic material is a ceramic powder, a metal oxide powder, a composite metal oxide powder or combinations thereof. The inorganic adhesive has a worse chemical activity than other materials and a sintering temperature lower than that of the ceramic material. The inorganic adhesive can be the crystallized or non-crystallized glass. In addition, the first pre-mold plate 31 or the second pre-mold plate 32 further includes a polymeric adhesive, a plasticizer or an organic solvent. In the embodiment, the polymeric adhesive can be polyethylene glycol (PEG), polyvinyl butyal (PVB) or polyvinyl alcohol (PVA). The plasticizer can be dibotylphthalate (DBP). The organic solvent can be 1-Propanol extra pure, toluene or alcohol.

The fabricating processes of the ceramic of the present invention will be illustrated hereinafter. Firstly, the ceramic material with a lower sintering temperature is mixed with an inorganic adhesive to form a slurry. Herein, glass with a lower melting point temperature can be added into the slurry to lower the sintering temperature, and the liquid phase glass will help the following sintering process to obtain a denser sintered plate. In addition, in order to prepare the slurry with proper viscosity, a polymeric adhesive, a plasticizer or an organic solvent can be added into the slurry. After that, a scraper is applied to fabricate the first pre-mold plate 31 and the second pre-mold plates 32.

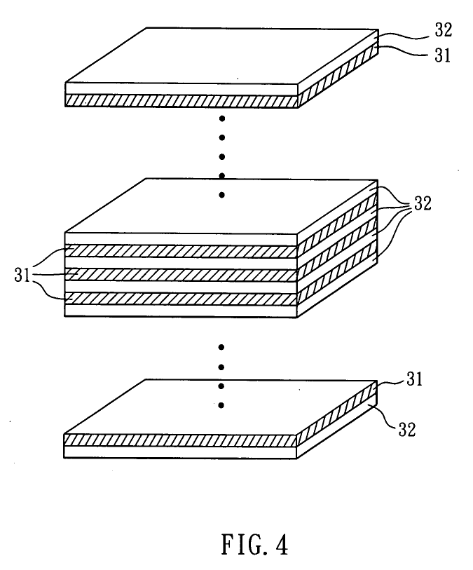

In the step S2, one second pre-mold plate 32, the first pre-mold plate 31 and the other second pre-mold plate 32 are stacked up in sequence. The sizes of the first pre-mold plate 31 and the second pre-mold plates 32 are substantially the same. As shown in FIG. 3, the two second pre-mold plates 32 respectively cover both opposite surfaces of the first pre-mold plate 31, i.e. the top surface and the bottom surface of the first pre-mold plate 31, so that a wrap can be prevent on the first pre-mold plate 31 during the sintering process. In the embodiment, the thickness of each second pre-mold plate 32 varies without limitation and can be adjusted depending on the thickness of the first pre-mold plate 31. To be noted, the stack including three pre-mold plates is only an example without limitation. The number of the stacked pre-mold plates varies depending on the actual requirement. As shown in FIG. 4, the first pre-mold plates 31 and the second pre-mold plates 32 are alternately stacked up, so that multiple first pre-mold plates 31, which may have different thicknesses, can be sintered and pressed at the same time.

Further, a step S21 can be performed after the step S2 to press the stacked first pre-mold plate 31 and second pre-mold plates 32. In the step S21, the stack of the first pre-mold plate 31 and the second pre-mold plates 32 is pressed by way of hot pressing and isostatic pressing to make the stack become denser and to prevent the pre-mold plates from warping during the subsequent sintering process.

In step S3, the stacked first pre-mold plate 31 and second pre-mold plates 32 are sintered at a temperature, which is the sintering temperature of the first pre-mold plate 31. Thus, the first pre-mold plate 31 can be sintered at this lower temperature to form the ceramic thin plate, and the second pre-mold plates 32 are not sintered yet. In the sintering process, the second pre-mold plates 32 can provide a pressure to prevent the warp of the first pre-mold plate 31. In addition, the non-sintered second pre-mold plates 32 may have several holes, which can be used for air passing from the first pre-mold plate 31 during the sintering process. Furthermore, the second pre-mold plates 32 can prevent the first pre-mold plate 31 from directly contacting with the sintering mold so as to avoid the possible pollution.

A step S31 can be performed after the step S3 to remove the second pre-mold plates 32 and then obtain the thin, planar and denser ceramic thin plate. In the embodiment, the ceramic thin plate is an LTCC substrate.

The method further includes a step S32 of testing the property of the ceramic thin plate after step S31. For example, an instrument is utilized to test the dielectric property and the quality property of the sintered ceramic thin plate, which include a dielectric constant (ε) and a quality factor (Q), so that the ceramic thin plate satisfying the specification can be obtained. To be noted, the step S32 can also be performed before the step S31 and after the step S3.

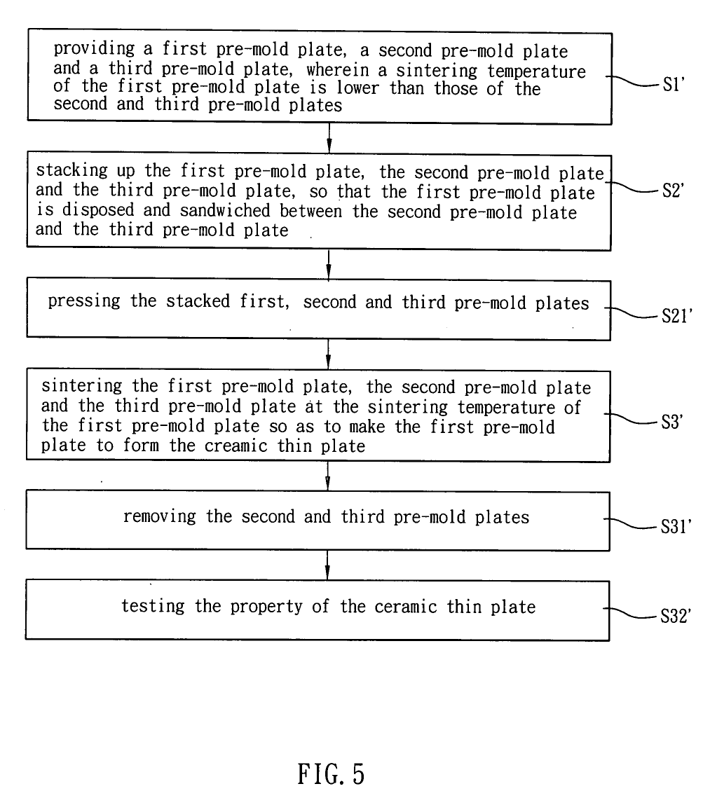

With reference to FIG. 5, another fabricating method of a ceramic thin plate according to a second embodiment of the present invention includes the following steps of S1′ to S3′. In step S1′, a first pre-mold plate, a second pre-mold plate and a third pre-mold plate are provided. In the embodiment, a sintering temperature of each of the second pre-mold plate and the third pre-mold plate is higher than that of the first pre-mold plate. In step S2′, the first pre-mold plate, the second pre-mold plate and the third pre-mold plate are stacked up. The first pre-mold plate is disposed and sandwiched between the second pre-mold plate and the third pre-mold plate. As shown in FIG. 3, one of the second pre-mold plates 32 is replaced by the third pre-mold plate. In step S3′, the first pre-mold plate, the second pre-mold plate and the third pre-mold plate are sintered at a temperature higher than the sintering temperature of the first pre-mold plate and lower than the sintering temperatures of the second and third pre-mold plates. After the sintering process, the first pre-mold plate can be sintered to form a ceramic thin plate.

After the step S2, the method further includes a step S21′ of pressing the stacked first, second and third pre-mold plates. In addition, after the step S3, the method may further include a step S31′ of removing the second and third pre-mold plates, and a step S32′ of testing a property of the ceramic thin plate. The implementing of the steps and the fabricating of the materials are described in the first embodiment, so the detailed descriptions will be omitted.

In addition, the second and third pre-mold plates can be different, such as having different sintering temperatures, as long as the second and third pre-mold plates both have a sintering temperature higher than that of the first pre-mold plate. Under this requirement, the second and third pre-mold plates can be disposed at both opposite surfaces of the first pre-mold plate to prevent the warp of the first pre-mold plate during the sintering process.

In summary, the fabricating method of a ceramic thin plate according to the present invention is to dispose a pre-mold plate with a lower sintering temperature, such as the first pre-mold plate, between two pre-mold plates with a higher sintering temperature, such as the second and third pre-mold plates. Then, the stacked pre-mold plates are sintered at the lower sintering temperature to make the first pre-mold plate to form a ceramic thin plate, while the second and third pre-mold plates are not sintered yet. In the present invention, the second and third pre-mold plates are used to apply stress on the opposite surfaces of the first pre-mold plate during the sintering process. Accordingly, the fabricated ceramic thin plate can be planar and without a warp and have good properties such as high density, dielectric and quality.

Although the present invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the present invention.

What is claimed is:

1. A fabricating method of a ceramic thin plate, the method comprising steps of:
providing at least one first pre-mold plate and at least two second pre-mold plates, wherein a sintering temperature of the second pre-mold plates is higher than that of the first pre-mold plate;
stacking up the first pre-mold plate and the second pre-mold plates, wherein the first pre-mold plate is disposed and sandwiched between the second pre-mold plates; and
sintering the first pre-mold plate and the second pre-mold plates at the sintering temperature of the first pre-mold plate so as to make the first pre-mold plate to form the ceramic thin plate.

2. The method according to claim 1, wherein after the step of stacking up the first pre-mold plate and the second pre-mold plates, the method further comprises a step of:
pressing the first pre-mold plate and the second pre-mold plates.

3. The method according to claim 2, wherein the first pre-mold plate and the second pre-mold plates are pressed by way of hot pressing and isostatic pressing so that a stack of the first pre-mold plate and the second pre-mold plates becomes denser.

4. The method according to claim 1, wherein after the step of sintering the first pre-mold plate and the second pre-mold plates, the method further comprises a step of:
testing a property of the ceramic thin plate.

5. The method according to claim 1, wherein after the step of sintering the first pre-mold plate and the second pre-mold plates, the method further comprises steps of:
removing the second pre-mold plates; and
testing a property of the ceramic thin plate.

6. The method according to claim 1, wherein the first pre-mold plate or the second pre-mold plates is formed by mixing at least one ceramic material and an inorganic adhesive.

7. The method according to claim 6, wherein the ceramic material is selected from the group consisting of a ceramic powder, a metal oxide powder, a composite metal oxide powder and combinations thereof.

8. The method according to claim 6, wherein the inorganic adhesive is crystallized glass or non-crystallized glass or a glass ceramic, or the inorganic adhesive has a worse chemical activity than other materials and a sintering temperature lower than that of the ceramic material, and is in a liquid phase during a sintering process.

9. The method according to claim 6, wherein the first pre-mold plate or the second pre-mold plate further comprises a polymeric adhesive, a plasticizer or an organic solvent.

10. The method according to claim 9, wherein the polymeric adhesive is polyethylene glycol (PEG), polyvinyl butyal polyvinyl butyal (PVB) or polyvinyl alcohol (PVA), the plasticizer is dibotylphthalate (DBP), and the organic solvent is 1-Propanol extra pure, toluene or alcohol.

11. The method according to claim 1, wherein the first pre-mold plate and the second pre-mold plate substantially have the same size, and the ceramic thin plate is an LTCC substrate.

12. A fabricating method of a ceramic thin plate, the method comprising steps of:
providing a first pre-mold plate, a second pre-mold plate and a third pre-mold plate, wherein a sintering temperature of the first pre-mold plate is lower than those of the second pre-mold plate and the third pre-mold plate;
stacking up the first pre-mold plate, the second pre-mold plate and the third pre-mold plate, wherein the first pre-mold plate is disposed and sandwiched between the second pre-mold plate and the third pre-mold plate; and
sintering the first pre-mold plate, the second pre-mold plate and the third pre-mold plate at the sintering temperature of the first pre-mold plate so as to make the first pre-mold plate to form the ceramic thin plate.

13. The method according to claim 12, wherein after the step of stacking up the first pre-mold plate, the second pre-mold plate and the third pre-mold plate, the method further comprises a step of:
pressing the first pre-mold plate, the second pre-mold plate and the third pre-mold plate.

14. The method according to claim 13, wherein the first pre-mold plate, the second pre-mold plate and the third pre-mold plate are pressed by way of hot pressing and isostatic pressing so that a stack of the first pre-mold plate, the second pre-mold plate and the third pre-mold plate becomes denser.

15. The method according to claim 12, wherein after the step of sintering the first pre-mold plate, the second pre-mold plate and the third pre-mold plate, the method further comprises steps of:
removing the second pre-mold plate and the third plate; and
testing a property of the ceramic thin plate.

16. The method according to claim 12, wherein each of the first pre-mold plate, the second pre-mold plate and the third pre-mold plate is formed by mixing at least one ceramic material and an inorganic adhesive.

17. The method according to claim 16, wherein the ceramic material is selected from the group consisting of a ceramic powder, a metal oxide powder, a composite metal oxide powder and combinations thereof.

18. The method according to claim 16, wherein the inorganic adhesive is crystallized glass or non-crystallized glass or a glass ceramic, or the inorganic adhesive has a worse chemical activity than other materials and a sintering temperature lower than that of the ceramic material, and is in a liquid phase during a sintering process.

19. The method according to claim 16, wherein the first pre-mold plate, the second pre-mold plate or the third pre-mold plate further comprises a polymeric adhesive, a plasticizer or an organic solvent, and the polymeric adhesive is polyethylene glycol (PEG), polyvinyl butyal polyvinyl butyal (PVB) or polyvinyl alcohol (PVA), the plasticizer is dibotylphthalate (DBP), and the organic solvent is 1-Propanol extra pure, toluene or alcohol.

20. The method according to claim 12, wherein the second pre-mold plate and the third pre-mold plate have different sintering temperatures.
